(19) United States
(12) Patent Application Publication
(10) Pub. No.: US 2005/0249436 A1
(43) Pub. Date: Nov. 10, 2005

(54) Apparatus and method for scaling digital data

(76) Inventors: Andy Chiu, Hsin Tien City (TW); Denzel Wang, Hsin Tien City (TW); Sheng-Che Tsao, Hsin Tien City (TW)

Correspondence Address: BRUCE H. TROXELL, Suite 1404, 5205 Leesburg Pike, Falls Church, VA, 22041, US

(21) Appl. No.: 11/120,967

(22) Filed: May 4, 2005

(30) Foreign Application Priority Data
May 4, 2004 (TW) 93112466

(51) Int. Cl. G06K 9/32

(52) U.S. Cl. 382/298

(57) ABSTRACT

A data processing apparatus and method used to scale a set of digital data is disclosed. The data processing apparatus comprises a ratio conversion module, which receives a ratio signal thereto generate a look-up table; and a scaling module connected to the ratio conversion module. The ratio conversion module generates a second set digital data based on the look-up table, and the first set digital data, by performing a digital scaling process.

### FIELD OF THE INVENTION

The invention relates to an apparatus and method for data processing, particularly to the apparatus and method can scale up or scale down digital data.

### DESCRIPTION OF THE PRIOR ART

We have, in recent years, moved into a highly information-oriented era. The computer technology is developing and maturing rapidly, pushing digital technology into every aspect of human life. Digital format data are much easier to process than do analog format ones. For example, when image quality and size of a digitized image is not satisfied perhaps due to the limited capacity or functions of the image's fetching device, an image processing techniques can be used to scale up low resolution images or scale down high-resolution images.

When an image is too big or too small to be displayed or processed on the computer screen, scaling operation is required. An image in dot matrix format is composed of numerous pixels, just as an image on the screen is composed of numerous light dots. Numerous individual pixels of different colors together constitute a digital image. As the number of the pixels that constitutes a digital image is limited by the capacity of the image's acquisition device, scaling or rotating the image might alter the image's resolution, causing distortion. Generally, a digital image is scaled up or down by removing or adding pixels to the image in an even and uniform manner. However, simply adding or removing pixels similar to those in their neighborhood without further processing the image when performing image scaling, the output image will suffer rough edges (serrated edges) or eve deformational distortions.

### SUMMARY OF THE INVENTION

A data processing apparatus used to scale a set of digital data is disclosed. The data processing apparatus comprises a ratio conversion module, and a scaling module. The ratio conversion module receives a ratio signal thereto generate a look-up table.

The scaling module connected to the ratio conversion module. The ratio conversion module generates a second set digital data based on the look-up table, and a first set digital data, by performing a digital scaling process.

A method for scaling a first set digital data according to the ratio signal is also provided. The method comprises receiving a ratio signal thereto generate a look-up table; receiving the first set digital data and then scaling according to the look-up table, and output a second set of digital data.

The advantages and features of the present invention will be better understood with the aid of the following detailed descriptions and illustrative figures.

### DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is the diagram of the data processing apparatus of the present invention.

FIG. 2 is an embodiment of a look-up table stored in ratio conversion module.

FIG. 3 is a diagram showing the conversion process.

FIG. 4 is a diagram showing the process of image scaling down.

FIG. 5 is a diagram showing the process of image scaling up.

FIG. 6 is a diagram showing the process of voiceprint scaling down according to another embodiment of the present invention.

FIG. 7 is a flow chart according to the present invention.

### DESCRIPTION OF PREFERRED EMBODIMENTS

An example of the preferred embodiments of the present invention is a data processing apparatus, used to receive a ratio signal and a first set digital data and, according to the ratio signal, perform scaling on the first set digital data.

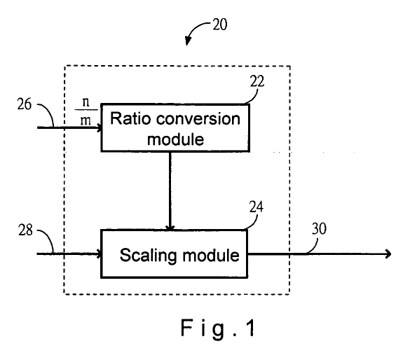

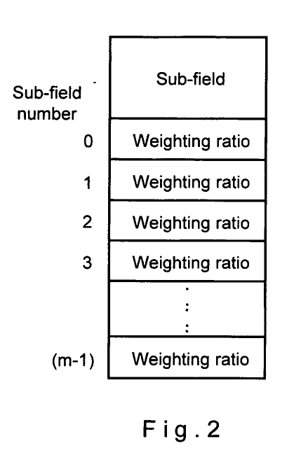

Please refer to FIG. 1 and FIG. 2. FIG. 1 illustrates the data processing apparatus of the present invention. FIG. 2 shows the look-up table stored in the ratio conversion module 22 shown in FIG. 1. The ratio conversion module 22 is used to receive ratio signals 26 and to generate a look-up table accordingly. The scaling module 24 is used to receive the first set digital data 28 and is coupled to the ratio conversion module 22 to scale the first set digital data 28 according to the look-up table. The ratio conversion module 22 then outputs the second set digital data 30.

The ratio signal 26 in FIG. 1 represents the information of a scaling ratio

$$\frac{n}{m} .$$

When the ratio signal 26 is received by the ratio conversion module 22, a look-up table will be generated according to this scaling ratio, as shown in FIG. 2. The look-up table comprises m sub-fields, say, sub-field 0, sub-field 1, . . . , sub-field (m−1). The ratio conversion module 22 takes the reciprocal of the scaling ratio,

$$\frac{m}{n} ,$$

as the common difference and generates an arithmetic progression

$$0 , \frac{m}{n} , \frac{2 m}{n} , \frac{3 m}{n} , \frac{4 m}{n} , … , \frac{( n - 2 ) m}{n} , and \frac{( n - 1 ) m}{n} .$$

Each item is then converted into a mixed fraction, wherein the proper fraction is a weighting ratio and integer portion is a sub-field number corresponding to a sub-field. The proper fractions of the all items of the arithmetic progression will be stored into sub-fields according to their field number, respectively.

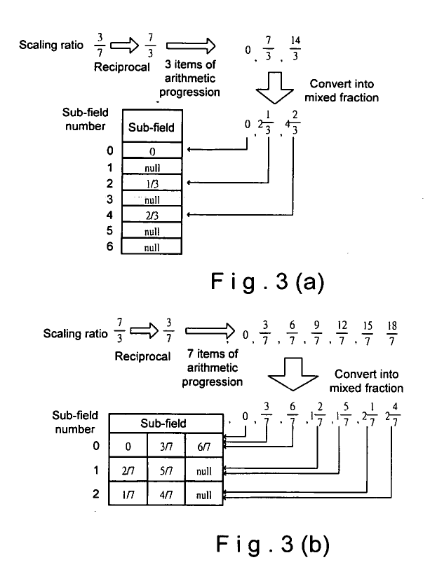

FIG. 3 showing an exemplary look-up table generating steps while the ratio conversion module 22 receives the ratio signal 26. Assuming the scaling ratio is identified to be

$$\frac{3}{7} ,$$

the ratio conversion module 22, thereafter, generates an arithmetic progression, starting from 0, and a common difference

$$\frac{7}{3} .$$

Hence, the arithmetic series is:

$$0 , \frac{7}{3} , \frac{14}{3} .$$

Each item is then converted into a mixed fractions series:

$$0 , 2 \frac{1}{3} , and 4 \frac{2}{3} .$$

The integer portions “0, 2, 4 stand for sub-field numbers, and the proper fraction portions, 0, ⅓, ⅔ stand for the weighting ratios are then being stored into the sub-fields whose sub-field number corresponds to. For example, 0, ⅓, ⅔ are stored, respectively, into the sub-field of the sub-field number 0, 2 and 4. The remnant sub-fields of segment numbers are denoted with null to represent the sub-field numbers without an integer portion to correspond, as are shown in FIG. 3(a).

Another embodiment is illustrates in FIG. 3(B), the scaling ratio is identified to be

$$\frac{7}{3} ,$$

and an arithmetic progression starting from 0 and by taking the reciprocal of

$$\frac{3}{7}$$

as a common difference so that the arithmetic progression:

$$0 , \frac{3}{7} , \frac{6}{7} , \frac{9}{7} , \frac{12}{7} , \frac{15}{7} , and \frac{18}{7}$$

is generated. Converting each item of the arithmetic progression into mixed fraction, we thus obtain series:

$$0 , \frac{3}{7} , \frac{6}{7} , 1 \frac{2}{7} , 1 \frac{5}{7} , 2 \frac{1}{7} , and 2 \frac{4}{7} .$$

Thereafter, the sub-field numbers generated thus include 0, 1, 2. The proper fractions represent weighting ratio, which include 0, 3/7, 6/7, 2/7, 5/7, 1/7, and 4/7. The proper fractions: 0, 3/7, 6/7 belong to sub-field number 0 and 2/7, 5/7 belong to sub-field number 1, and 1/7, and 4/7 belong to sub-field number 2 according to their integer portions. As shown in FIG. 3B, the numbers of the sub-fields is three, due to the maximum number of proper fraction among all sub-field numbers. The proper fractions are then stored into the sub-fields according to sub-field number. The remnant sub-fields without proper fraction to store are then denoted by null.

The preceding description is the process in which the ratio conversion module 22 receives a ratio signal 26, identifies the scaling ratio, and generates a look-up table. When scaling up an image, it is very often that two consecutive sub-segments are synthesized according to various weighting ratios; therefore, the look-up table generated for image scaling up requires at least one weight ratios for each sub-field number. One thing is for sure, the ratio conversion module 22 will reserve required sub-fields according to the arithmetic progression. On the other hand, those empty sub-fields denoted by null means no integer portion to match the corresponding sub-field numbers. When scaling image, the scaling module 24 will ignore those sub-fields with null.

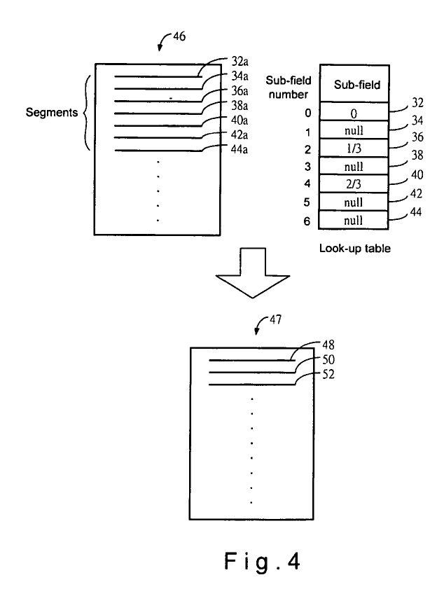

Please refer to FIG. 4, which is a diagram of showing the process of image scaling down. When the ratio conversion module 22 receives a ratio signal and identifies it to be

$$\frac{3}{7} ,$$

a look-up table is generated and stored in ratio conversion module 22, of which the process is described in FIG. 2, not intended to be repeated here. There are seven weighting ratio 0, null, ⅓, null, ⅔, null, respectively, in the sub-fields 32, 34, 36, 38, 40, 42, and 44, corresponding to the sub-segments 32a, 34a, 36a, 38a, 40a, 42a, and 44a of the digital image source 46.

The scaling module 24 processes the image source 46 scaling according to the weight ratio in the corresponding sub-fields of the look-up table. An example is illustrating as follows: the quality of sub-segment 32a multiplied by

$$( 1 - \frac{0}{3} )$$

and the next sub-segment 34a multiplied by

$$\frac{0}{3}$$

are combined to obtain the sub-segment 48 in resulted digital image 47. Since the sub-field 34 (sub-field number 1) is null, the scaling ratio in the look-up table is thus skipped. Thereafter, the quality of sub-segment 36a multiplied by

$$( 1 - \frac{1}{3} )$$

and that of sub-segment 38a multiplied by

$$\frac{1}{3}$$

are combined to obtain the sub-segment 50 in the resulted digital image 47. Furthermore, the quality of sub-segment 40a multiplied by

$$( 1 - \frac{2}{3} )$$

and that of sub-segment 42a multiplied by

$$\frac{2}{3}$$

are combined to obtain the sub-segment 52 in resulted digital image 47. Aforementioned steps are repeatedly through all weight ratios in the look-up table and corresponding sub-segments in the digital image source 46, the resulted digital image 47 will be the original digital image 46 scaled by

$$\frac{3}{7}$$

in vertical direction thereof. Since each sub-segment in the output is the combination obtained from the neighboring sub-segments, no roughness or discontinuities are observed in the output image due to image scaling down.

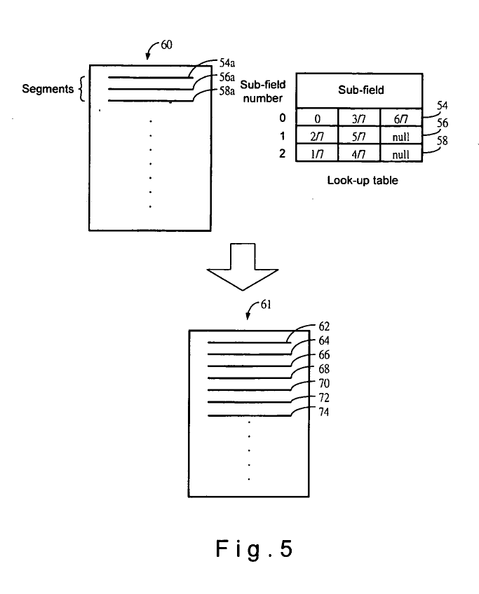

Please refer to FIG. 5, which shows a diagram showing the process of image scaling up. When the ratio conversion module 22 receives a ratio signal and identifies it to be

$$\frac{7}{3} ,$$

a look-up table is generated and stored in ratio conversion module 22, of which the process is described in FIG. 2, as depicted before. Every two consecutive sub-segments will be combined according to various weight ratios. As shown in FIG. 5, the look-up table is stored in the ratio conversion module 22, which contains sub-fields 54, 56, and 58 corresponding to the sub-segments 54a, 56a, and 58a in digital image source 60 respectively. The weight ratios of sub-field 54 (sub-field number 0) are

$$\frac{0}{7} , \frac{3}{7} , \frac{6}{7} ;$$

sub-field 56 (sub-field number 1) are

$$\frac{2}{7} , \frac{5}{7} ,$$

and sub-field (sub-field number 2) 58 are

$$\frac{1}{7} , \frac{4}{7} .$$

The remnant sub-segments are being denoted with null. Hence, scaling module 24 combines the sub-segments in digital image source 60 with the weight ratios in the corresponding look-up table, i.e. the quality of sub-segment 54a multiplied by

$$( 1 - \frac{0}{7} )$$

and that of sub-segment 56a multiplied by

$$\frac{0}{7}$$

are combined to obtain sub-segment 62 in the resulted digital image 61; the quality of sub-segment 54a multiplied by

$$( 1 - \frac{3}{7} )$$

and that of sub-segment 56a multiplied by

$$\frac{3}{7}$$

are combined to obtain the sub-segment 64 in resulted digital image 61; the quality of sub-segment 54a multiplied by

$$( 1 - \frac{6}{7} )$$

and that of sub-segment 56a multiplied by

$$\frac{6}{7}$$

are combined to obtain the sub-segment 66 in resulted digital image 61. All the sub-segments in digital image source 60 are combined by the rule as above, thus not intended to be repeated here. Using the same look-up table, perform the combination repeatedly on consecutive sub-segments of digital image source 60, the resulted output digital image 61 is the digital image 60 is scaled by 7/3 in vertical direction thereof. Since each sub-segment in the output is the combination obtained from the neighboring sub-segments, no roughness or discontinuities are observed in the output image during image scaling up.

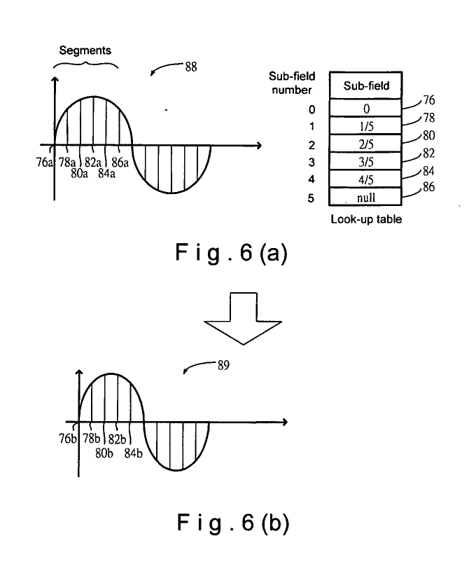

Please refer to FIG. 6, which is a diagram showing the process of voiceprint scaling down according to another embodiment of the present invention. In FIG. 6(a), the voiceprint 88 was sampled digitally and therefore obtained sub-segments: 76a, 78a, 80a, 82a, 84a, and 86a. The ratio conversion module 22 receives a ratio signal and identifies the scaling ratio to be

$$\frac{5}{6} ,$$

it then obtains a arithmetical series

$$0 , 1 \frac{1}{5} , 2 \frac{2}{5} , 3 \frac{3}{5} , 4 \frac{4}{5}$$

with the increment,

$$\frac{6}{5} ,$$

by taking the reciprocal of the scaling ratio, in which the proper fraction portion represents the weight ration while the integer portion stands for the sub-field number as mentioned before. The look-up table in FIG. 6 is stored in ratio conversion module 22, which consists of 6 sub-fields: 76, 78, 80, 82, 84, and 86, which are all mapped respectively onto the sub-segments 76a, 78a, 80a, 82a, 84a, and 86a, that are sampled from corresponding voiceprint 88. The weighting ratios of sub-fields 76, 78, 80, 82, 84, and 86 are, respectively,

$$0 , \frac{0}{5} , \frac{1}{5} , \frac{2}{5} , \frac{3}{5} , \frac{4}{5} ,$$

null. Hence, the scaling module 24 will combine the sub-segments in voiceprint 88 with the corresponding weight ratio in the look-up table, e.g. the quality of sub-segment 80a multiplied by

$$( 1 - \frac{2}{5} )$$

and that of sub-segment 82a multiplied by

$$\frac{2}{5}$$

are combined to obtain the sub-segment 80b in voiceprint 89; the quality of sub-segment 84a multiplied by

$$( 1 - \frac{4}{5} )$$

and that of sub-segment 86a multiplied by

$$\frac{4}{5}$$

are combined to obtain the sub-segment 84b in voiceprint 89. Using the same look-up table, perform the combinations as forgoing steps on consecutive segments of voiceprint 88, then the resulted output voiceprint 89 is the original voiceprint 88 multiplied by

$$\frac{5}{6}$$

in horizontal direction thereof. In addition, each sub-segment in the output is the combination obtained from the neighboring sub-segments, no roughness or discontinuities in the output voiceprint 89 will arise from condensation. On the other hand, supposed that the voiceprint shown in FIG. 6a is a male voiceprint, after scaling down, it turns out to be a higher-pitched female voiceprint, as is shown in FIG. 6b.

According to the forgoing embodiments, in the case of image scaling down, scaling module 24 combines the corresponding sub-segments based on the consecutive sub-fields in the look-up table; the sub-segments after combination bear the same consecutive order. In the case of image scaling up, the scaling module 24 combines the corresponding sub-segments from left to right consecutively, based on the sub-segments in the look-up table; the sub-segments are arranged in successive order, thus the enlarged image is free of discontinuity to the naked eye. In the case of voiceprint shrinkage, since the digital sampling was used to obtain the sub-segments in clusters, an identical operation was used to shrink the voiceprint, i.e. change the pitch. Accordingly, the processes of the data processing apparatus according to the present invention is by receiving a ratio signal and a first set digital data, then generating a look-up table by identifying the scaling ratio according to the ratio signal. Thereafter, combining two consecutive sub-segments to produce a processed sub-segment with the corresponding weight ratios in the look-up table is performed. Finally, second set digital data is then outputted. The second set digital data, each is combined from the sub-segments in the first set digital data. Therefore, the processed image by the data processing apparatus in accordance with the present invention will not cause any roughness or discontinuity.

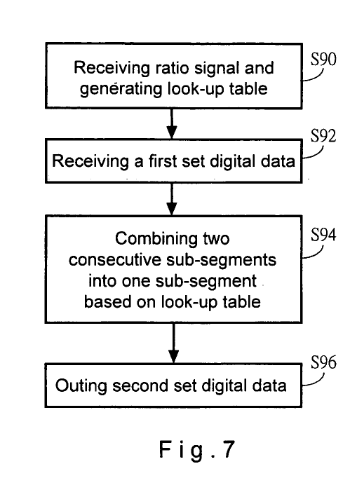

Please refer to FIG. 7, which is a flow chart in accordance with the present invention, in which the following steps are comprised.

Step S90: Receiving a ratio signal and generating a look-up table accordingly.

Step S92: Receiving the first set digital data.

Step S94: performing combination of two consecutive sub-segments of the first set digital data into a sub-segment based on the look-up table.

Step S96: Outputting the second set digital data.

Comparing with known digital data scaling apparatus and methods, the data processing apparatus in the present invention perform the combination operations on two consecutive sub-segments of the first set digital data with the weighting ratio stored in the look-up table, in order to scale up or scale down the first set digital data, and improve the known technical defects dramatically.

Through the description in the above improved embodiment, it is hoped that the characteristics and essence of the present invention can be expressed clearer. However, the above descriptions are merely certain optimized embodiment cases, which are not intended to confine the embodiment of the present invention. That is to say the analogical alteration and modification are still under the coverage of the present invention.

1. A data processing apparatus for scaling a first set digital data, comprising:
a ratio conversion module for receiving a ratio signal and generating a look-up table; and
a scaling module coupled to the ratio conversion module for receiving and scaling the first set digital data according to the look-up table, and output a second set digital data.

2. The data processing apparatus as in claim 1, wherein the scaling module allocates the first set digital data into a plurality of segments, and each of the segments comprises a plurality of sub-segments.

3. The data processing apparatus as in claim 2, wherein the look-up table corresponds to each of the segments, and the look-up table comprises a plurality of sub-fields corresponding to the sub-segments, respectively.

4. The data processing apparatus as in claim 3, wherein the ratio signal identifies a scaling ratio
$$\frac{n}{m} ,$$
and the conversion module generates an arithmetic progression having a common difference according to the scaling ratio.

5. The data processing apparatus as in claim 4, the common difference is reciprocal of the scaling ratio,
$$\frac{m}{n} ,$$
and the arithmetic progression has (n) items, which starts from 0

6. The data processing apparatus as in claim 4, wherein the ratio conversion module converts each item of the progressive progression into a mixed fraction having a proper fraction portion standing for weighting ratio, and an integer portion standing for a sub-field number corresponding to the sub-field.

7. The data processing apparatus as in claim 6, the ratio conversion module stores the proper fraction standing for weighting ratio into the sub-field corresponding to the sub-field number, and denotes null into other sub-fields corresponding to nothing.

8. The data processing apparatus as in claim 7, wherein the scaling module synthesizes two consecutive sub-segments in a predetermined rule based on the look-up table and constitutes the second set digital data by synthesized sub-segments.

9. The data processing apparatus as in claim 8, the scaling module synthesizes sub-segments based on each of the sub-fields of the look-up table from the sub-field number 0 to (n−1) and if the K-th sub-field contains more than one weight ratios, the weight ratios referred from left to right.

10. The data processing apparatus as in claim 8, wherein the predetermined rule as follow:
a synthesized sub-segment is obtained by
$$( quality of the K \text{-} th sub \text{-} segment * ( 1 - \frac{b}{a} ) )$$
combined with (quality of the (K+1)-th sub-segment, where “*” is a multiple operator;
the combination operation for K-th and (K+1)-th sub-segment is ignored if the weight ratio in the sub-segment K is null.

11. A data processing method for scaling a first set digital data comprising:
receiving a ratio signal thereto generate a look-up table;
receiving the first set digital data;
scaling based on the look-up table; and
outputting a second set of digital data.

12. The data processing method as in claim 11, further comprising allocating the first set digital data into a plurality of segments, and each of the segments comprises a plurality of sub-segments.

13. The data processing method as in claim 12, wherein the look-up table corresponds to each of the segments, and the look-up table comprises a plurality of sub-fields corresponding to the sub-segments, respectively.

14. The data processing method as in claim 13, further comprising generating an arithmetic progression having a common difference according to the scaling ratio, wherein the ratio signal identifies a scaling ratio
$$\frac{n}{m} .$$

15. The data processing method as in claim 14, wherein the common difference is reciprocal of the scaling ratio,
$$\frac{m}{n} ,$$
and the arithmetic progression starts from 0 to (n−1) items.

16. The data processing method as in claim 14, further comprising converting each item of the progressive progression into a mixed fraction having a proper fraction portion standing for weighting ratio, and an integer portion standing for a sub-field number corresponding to the sub-field.

17. The data processing method as in claim 16, further comprising storing the proper fraction standing for weighting ratio into the sub-field corresponding to the sub-field number, and denoting null into other sub-fields corresponding to nothing.

18. The data processing method as in claim 17, wherein further comprising synthesizing two consecutive sub-segments in a predetermined rule based on the look-up table and constituting the second set digital data by synthesized sub-segments.

19. The data processing method as in claim 18, wherein synthesizing sub-segments is based on each of the sub-fields of the look-up table from the sub-field number 0 to (n−1) and if the K-th sub-field contains more than one weight ratios, the weight ratios from referred left to right.

20. The data processing method as in claim 18, wherein the predetermined rule as follow:
a synthesized sub-segment is obtained by
$$( quality of the K \text{-} th sub \text{-} segment * ( 1 - \frac{b}{a} ) )$$
combined with (quality of the (K+1)-th sub-segment, where “*” is a multiple operator;
the combination operation for K-th and (K+1)-th sub-segment is ignored if the weight ratio in the sub-segment K is null.
